(19) United States
(12) Patent Application Publication
(10) Pub. No.: US 2019/0230269 A1
(43) Pub. Date: Jul. 25, 2019

(54) MONITORING CAMERA, METHOD OF CONTROLLING MONITORING CAMERA, AND NON-TRANSITORY COMPUTER-READABLE STORAGE MEDIUM

(71) Applicant: CANON KABUSHIKI KAISHA, Tokyo (JP)

(72) Inventor: Takao Saito, Kawasaki-shi (JP)

(21) Appl. No.: 16/249,070

(22) Filed: Jan. 16, 2019

(30) Foreign Application Priority Data
Jan. 24, 2018 (JP) 2018-009940

(51) Int. Cl. H04N 5/235; H04N 7/18; H04N 5/225

(52) U.S. Cl. CPC H04N 5/2353; H04N 5/2258; H04N 7/183; H04N 5/2351

(57) ABSTRACT

A monitoring camera, having a first image capturing unit capable of changing an image capturing area for tracking capturing and a second image capturing unit capable of capturing a wider angle than the first image capturing unit, acquires, from an image captured by the second image capturing unit, luminance information of an image region corresponding to the image capturing area of the first image capturing unit for a next frame. The monitoring camera controls exposure for the first image capturing unit based on the luminance information.

### BACKGROUND OF THE INVENTION

### Field of the Invention

The present invention relates to a monitoring camera, a method of controlling a monitoring camera, and a non-transitory computer-readable storage medium, particularly to a technique for monitoring.

### Description of the Related Art

Conventionally, there is a monitoring apparatus that, to effectively monitor a wide monitoring region, performs monitoring using two cameras: a wide-angle camera having a wide-angle lens for capturing an entire monitoring region, and a zoom camera having a zoom mechanism for capturing an object in detail. A user can view the entire monitoring region by viewing an image captured by the wide-angle camera, and can view in detail a target object therein that they wish to give particular focus to by an image captured by the zoom camera.

For example, Japanese Patent Laid-Open No. 2002-247424 discloses a monitoring apparatus that contains, in the same camera case, an image input camera for acquiring a monitoring image to be used for detection, and a monitoring camera for performing tracking capturing of a detected object. By monitoring the entire monitoring region by the image input camera, the monitoring camera can detect a target object that has intruded into the monitoring region. Furthermore, at this point, by outputting information such as position, size, or luminance, as intruding object information to the camera control unit, the monitoring camera can further perform capturing while tracking the detected target object.

When performing tracking capturing, a scene where the luminance greatly changes, such as from a sunny area to shaded area, during movement of the object can be considered. However, if the luminance greatly changes during tracking, it is possible for the object to be lost. Even if the object is not lost, because a luminance change occurs for the object, there are cases where a capturing result is not suitable as a tracking video image. With the conventional technique disclosed in Japanese Patent Laid-Open No. 2002-247424 described above, luminance information of an object is transmitted from the image input camera to the monitoring camera, but when the object is far, it is difficult to detect the object with the image input camera whose angle of view is necessarily wide. In addition, when consideration is given to having an image input camera where a wide angle of view is configured using a plurality of cameras, it is considered that transmitted luminance information will vary due to variation of each camera, for example, and object luminance of a monitoring camera image will vary based on this information.

### SUMMARY OF THE INVENTION

The present invention provides a technique for appropriately controlling exposure in tracking capturing, even if luminance of an image capturing area greatly changes.

According to the first aspect of the present invention, there is provided a monitoring camera, comprising: a first image capturing unit capable of changing an image capturing area for tracking capturing; a second image capturing unit capable of capturing a wider angle than the first image capturing unit; an acquisition unit configured to acquire luminance information of an image region corresponding to an image capturing area of the first image capturing unit in a next frame, from an image captured by the second image capturing unit; and a control unit configured to control exposure for the first image capturing unit based on the luminance information.

According to the second aspect of the present invention, there is provided a method of controlling a monitoring camera having a first image capturing unit capable of changing an image capturing area for tracking capturing, and a second image capturing unit capable of capturing a wider angle than the first image capturing unit, the method comprising: acquiring luminance information of an image region corresponding to an image capturing area of the first image capturing unit in a next frame, from an image captured by the second image capturing unit; and controlling exposure for the first image capturing unit based on the luminance information.

According to the third aspect of the present invention, there is provided a non-transitory computer-readable storage medium storing a program for causing a computer to function as: a first acquisition unit configured to acquire captured images from a first image capturing unit for which it is possible to change an image capturing area for tracking capturing, and a second image capturing unit for which capturing of wider angle than the first image capturing unit is possible; and a second acquisition unit configured to acquire luminance information of an image region corresponding to an image capturing area of the first image capturing unit in a next frame, from an image captured by the second image capturing unit; and a control unit configured to control exposure for the first image capturing unit based on the luminance information.

Further features of the present invention will become apparent from the following description of exemplary embodiments (with reference to the attached drawings).

### BRIEF DESCRIPTION OF THE DRAWINGS

FIG. 1 is a schematic drawing which illustrates an example of an appearance of a monitoring apparatus.

FIG. 2 is a block diagram which illustrates an example of a functional configuration of a monitoring apparatus 100.

FIG. 3 is a block diagram which illustrates an example of a configuration of the monitoring apparatus 100 according to a second variation.

FIG. 4 is a view which illustrates an example of operation of a zoom camera 102 and a wide-angle camera 101.

FIG. 5 is a view which illustrates a luminance distribution according to captured images of multiple wide-angle cameras.

FIG. 6 is a flowchart of processing which the monitoring apparatus 100 performs.

FIG. 7 is a flowchart of processing which the monitoring apparatus 100 performs.

FIG. 8 is a block diagram which illustrates an example of a configuration of a system.

### DESCRIPTION OF THE EMBODIMENTS

Below, explanation will be given for embodiments of present invention with reference to the accompanying drawings. Note that embodiments described below merely illustrate examples of specifically implementing the present invention, and are only specific embodiments of a configuration defined in the scope of the claims.

### First Embodiment

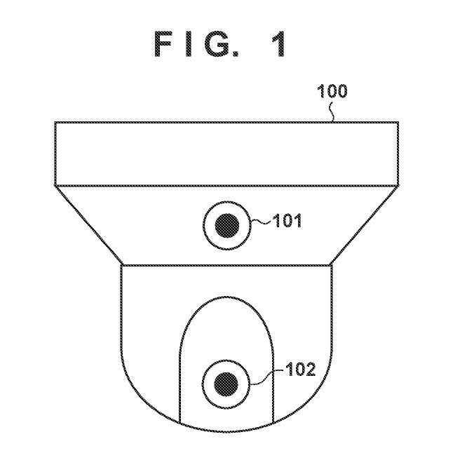

First, description will be given regarding an example of an appearance of a monitoring apparatus (a monitoring camera) according to embodiments using the schematic drawing of FIG. 1. As illustrated by FIG. 1, the monitoring apparatus 100 according to the present embodiment includes a wide-angle camera 101 and a zoom camera 102. The wide-angle camera 101 is an example of an image capturing apparatus for monitoring (capturing) the entirety of a monitoring region (a wide field of view), and includes a wide-angle lens. The zoom camera 102 is an example of an image capturing apparatus that is capable of capturing that tracks an object, and is a camera in which it is possible to change a pan (P), a tilt (T), and a zoom (Z). Specifically, the zoom camera 102 can capture detail of a partial region of an image capturing area (monitoring region) in accordance with the wide-angle camera 101 by zooming to the partial region by performing a zoom operation. In addition, by performing a pan operation or a tilt operation, the zoom camera 102 can change the image capturing area of the zoom camera 102 within the image capturing area by the wide-angle camera 101, and can capture the entire region of the monitoring region or any partial region within the monitoring region.

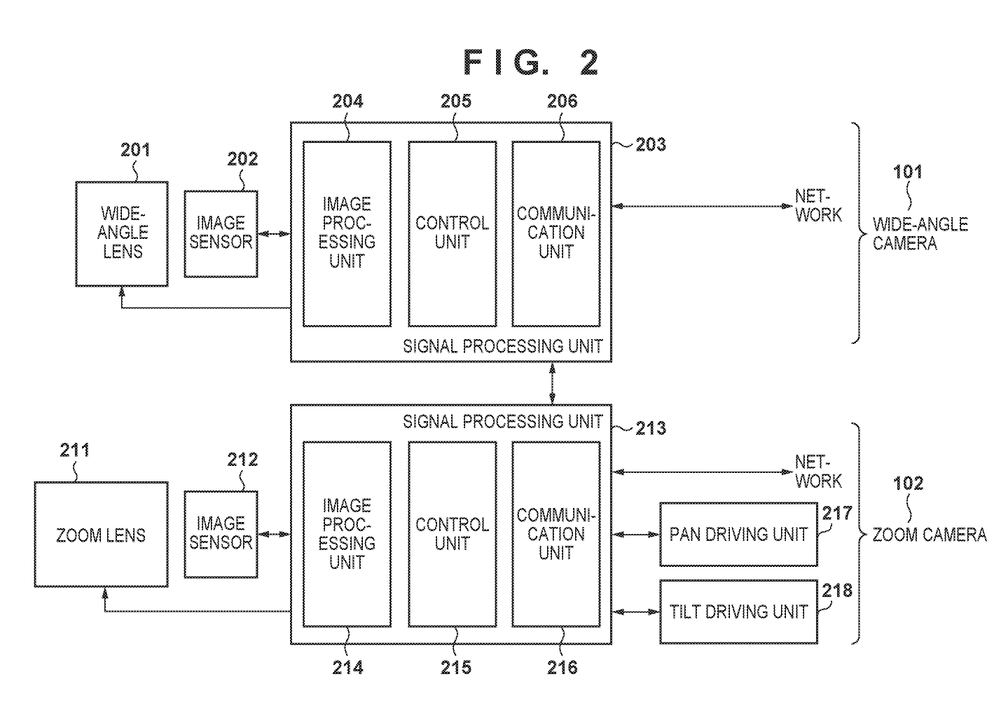

Next, using the block diagram of FIG. 2, description is given regarding an example of a functional configuration of the monitoring apparatus 100. Firstly, description is given regarding an example of the functional configuration of the wide-angle camera 101. Light from the external world enters an image sensor 202 via a wide-angle lens 201, and the image sensor 202 outputs an electrical signal in accordance with this light to a signal processing unit 203. The signal processing unit 203 has an image processing unit 204, a control unit 205, and a communication unit 206. The image processing unit 204 generates a captured image based on the electrical signal from the image sensor 202, and, after performing image processing including various correction processing on the generated captured image, outputs the captured image to the communication unit 206. The image processing unit 204 performs this series of processing each time an electrical signal is received from the image sensor 202, and successively generates a plurality of frames of captured images, and outputs them to the communication unit 206. The control unit 205 has one or more processors and a memory, and the processor executes processing by using data and a computer program stored in the memory to perform operation control of the entirety of the wide-angle camera 101. For example, the control unit 205 controls the wide-angle lens 201 or the image sensor 202 so that a captured image outputted from the image processing unit 204 is adequate (for example, so that exposure is adequate). The communication unit 206 transmits, to an external device and via a network, a captured image that is outputted from the image processing unit 204. In addition, the communication unit 206 performs data communication with the zoom camera 102 as necessary.

Next, description is given regarding an example of the functional configuration of the zoom camera 102. A zoom lens 211, in accordance with control by a control unit 215, performs a zoom operation for zooming in so as to capture detail of an object in the image capturing area of the zoom camera 102, or zooming out so as to capture a wider area. Light from the external world enters an image sensor 212 via the zoom lens 211, and the image sensor 212 outputs an electrical signal in accordance with this light to a signal processing unit 213. The signal processing unit 213 has an image processing unit 214, the control unit 215, and a communication unit 216. The image processing unit 214 generates a captured image based on the electrical signal from the image sensor 212, and, after performing image processing including various correction processing on the generated captured image, outputs the captured image to the communication unit 216. The image processing unit 214 performs this series of processing each time an electrical signal is received from the image sensor 212, and successively generates a plurality of frames of captured images, and outputs them to the communication unit 216. The control unit 215 has one or more processors and a memory, and the processor executes processing by using data and a computer program stored in the memory to perform operation control of the entirety of the zoom camera 102. For example, the control unit 215 controls the zoom lens 211 or the image sensor 212 so that a captured image outputted from the image processing unit 214 is adequate (for example, so that exposure is adequate). A pan driving unit 217 performs a pan operation for changing an angle in the pan direction of the zoom camera 102, in accordance with control by the control unit 215. A tilt driving unit 218 performs a tilt operation for changing an angle in the tilt direction of the zoom camera 102, in accordance with control by the control unit 215. In other words, the control unit 215 performs driving control of the zoom lens 211, the pan driving unit 217, or the tilt driving unit 218 to enable capturing of any image capturing area. In addition, by such a configuration, simultaneous capturing by the wide-angle camera 101 and the zoom camera 102 is possible. The communication unit 216 transmits, to an external device and via a network, a captured image that is outputted from the image processing unit 214. A transmission destination of an image captured by the communication unit 216 may be the same as or different to a transmission destination of an image captured by the communication unit 206. In addition, information that the communication unit 206 and the communication unit 216 transmit to an external device via a network is not limited to captured images, and may be additional information such as information relating to an image capture date-time, a pan angle, a tilt angle, a zoom value, and information for an object recognized from a captured image. In addition, the communication unit 216 performs data communication with the wide-angle camera 101 as necessary.

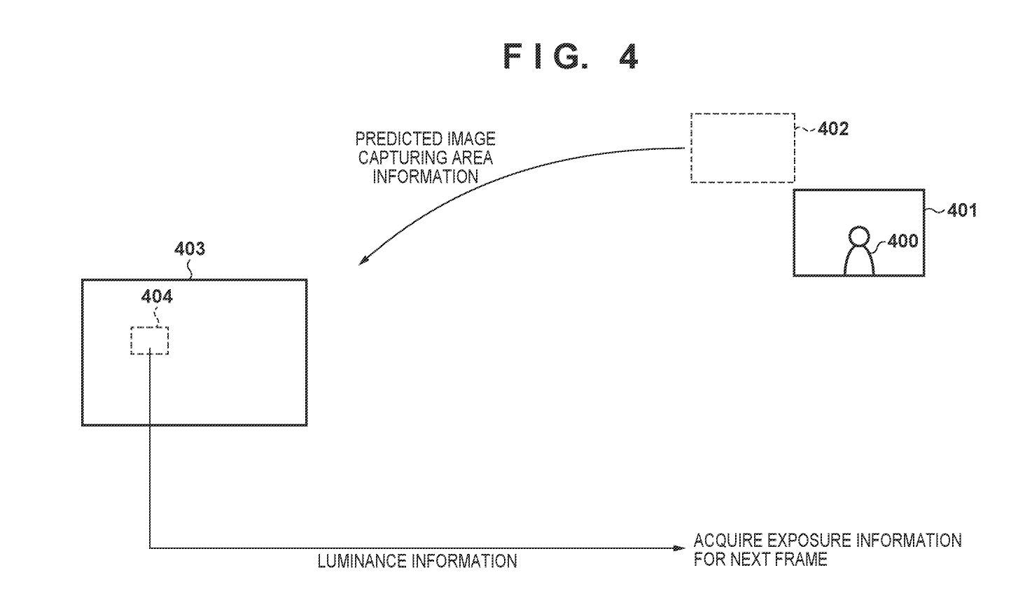

Next, taking FIG. 4 as an example, description is given regarding operation of the zoom camera 102 and the wide-angle camera 101 for enabling tracking capturing of an object by the zoom camera 102 while appropriately controlling exposure for the zoom camera 102.

The zoom camera 102 (the control unit 215) recognizes an object 400 appearing in a captured image 401 of a current frame, and identifies object information such as a movement direction, a size and a position in the captured image 401 for the recognized object 400. The control unit 215 calculates, from the identified object information, respective control amounts (control information) for a pan angle, a tilt angle, and a zoom value for the zoom camera 102 so that the object 400 fits within a captured image for a next frame. Processing for calculating respective control amounts for the pan angle, the tilt angle, and the zoom value can be realized by well-known functions for performing tracking capturing of an object. The control unit 215 identifies (predicts) an image capturing area (a predicted image capturing area) 402 of the zoom camera 102 in the next frame from the respective control amounts for the pan angle, the tilt angle, and the zoom value. More specifically, the control unit 215 identifies (estimates), as the predicted image capturing area 402, an image capturing area of the zoom camera 102 in a case where the pan angle, the tilt angle, and the zoom value of the zoom camera 102 are respectively changed in accordance with the obtained control amounts for the pan angle, the tilt angle, and the zoom value. The control unit 215 controls the communication unit 216 to output information (predicted image capturing area information) indicating the predicted image capturing area 402 to the wide-angle camera 101.

The wide-angle camera 101 (the control unit 205) controls the communication unit 206 to receive the predicted image capturing area information outputted from the zoom camera 102. The control unit 205 collects a luminance value (luminance information) of each pixel in an image region 404 corresponding to a predicted image capturing area indicated by the received predicted image capturing area information, in a captured image 403 in accordance with the wide-angle camera 101. According to such a configuration, the control unit 205 can collect luminance information for a region corresponding to the predicted image capturing area that includes the object, even if the object in the captured image is so small that detection is impossible. The control unit 205 controls the communication unit 206 to output the collected luminance information to the zoom camera 102.

The control unit 215 controls the communication unit 216, and upon acquiring the luminance information outputted from the wide-angle camera 101, by a well-known technique obtains from the acquired luminance information exposure information such as a shutter speed, an aperture, and a sensitivity (gain) to have an adequate exposure state. The control unit 215 controls the zoom lens 211 (strictly speaking a control unit for performing drive control of the zoom lens 211) and the image sensor 212 to change current exposure information of the zoom camera 102 to the exposure information obtained based on the luminance information outputted from the wide-angle camera 101. By this, the control unit 215 can change to an amount of exposure for capturing the object in the next frame by appropriate exposure, and can appropriately control the exposure.

In addition, the control unit 215 controls the pan driving unit 217 to change the pan angle of the zoom camera 102 in accordance with a calculated control amount for the pan angle, and controls the tilt driving unit 218 to change the tilt angle of the zoom camera 102 in accordance with a calculated control amount for the tilt angle. In addition, the control unit 215 controls the zoom lens 211 (strictly speaking a control unit for performing drive control of the zoom lens 211) to change the zoom of the zoom camera 102 in accordance with the calculated control amount for the zoom value. In this way, the control unit 215 can change the image capturing area by performing drive control of the pan driving unit 217, the tilt driving unit 218 and the zoom lens 211.

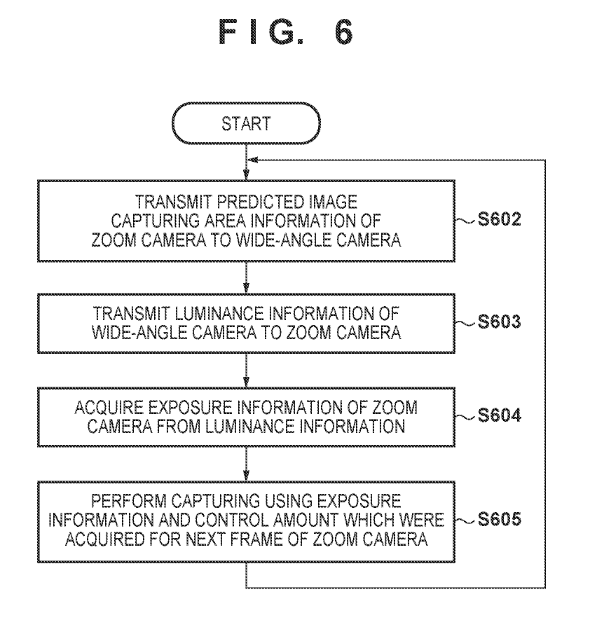

Next, description in accordance with the flowchart of FIG. 6 is given regarding processing performed by the monitoring apparatus 100 for enabling tracking capturing of an object by the zoom camera 102 while appropriately controlling exposure for the zoom camera 102. Note that, because details of the processing in each step of FIG. 6 is as described above, description is given simply here.

In step S602, the control unit 215 calculates, respective control amounts for a pan angle, a tilt angle, and a zoom value for the zoom camera 102 so that the object 400 fits within a captured image for a next frame. The control unit 215 identifies (predicts) the predicted image capturing area 402 of the image capturing area of the zoom camera 102 in the next frame from the respective control amounts for the pan angle, the tilt angle, and the zoom value. The control unit 215 controls the communication unit 216 to output the predicted image capturing area information indicating the predicted image capturing area 402 to the wide-angle camera 101.

In step S603, the control unit 205 collects a luminance value (luminance information) of each pixel in the image region 404 corresponding to a predicted image capturing area indicated by the predicted image capturing area information, in the captured image 403. The control unit 205 controls the communication unit 206 to output the collected luminance information to the zoom camera 102. In step S604, the control unit 215 by a well-known technique obtains from the luminance information exposure information such as a shutter speed, an aperture, and a sensitivity (gain) to have adequate exposure state.

In step S605, the control unit 215 controls the zoom lens 211 (strictly speaking a control unit for performing drive control of the zoom lens 211) and the image sensor 212 to change current exposure information of the zoom camera 102 to the exposure information obtained based on the luminance information acquired from the wide-angle camera 101. In addition, the control unit 215 controls the pan driving unit 217 to change the pan angle of the zoom camera 102 in accordance with a calculated control amount for the pan angle, and controls the tilt driving unit 218 to change the tilt angle of the zoom camera 102 in accordance with a calculated control amount for the tilt angle. In addition, the control unit 215 controls the zoom lens 211 (strictly speaking a control unit for performing drive control of the zoom lens 211) to change the zoom of the zoom camera 102 in accordance with the calculated control amount for the zoom value. The zoom camera 102 and the wide-angle camera 101 then perform capturing of next frames.

By virtue of the present embodiment in this way, it is possible to perform, with higher accuracy, recognition of an object (identification of its position, size, or the like) in a captured image for the next frame, because it is possible to perform capturing by an exposure suitable for the next frame, even if the luminance of an image capturing area greatly changes during tracking capturing. By this, for example, it is possible to solve a conventional problem such as “losing an object when luminance of the object abruptly changes”.

Note that each functional unit of the wide-angle camera 101 and the zoom camera 102 illustrated in FIG. 1 may be implemented as hardware, and each functional unit other than the control unit 205 (215) may be implemented as software (a computer program). In the latter case, the software is stored in a memory that the control unit 205 (215) has, and is executed by a processor that the control unit 205 (215) has.

### First Variation

If a current amount of exposure of the zoom camera 102 is comparatively greatly different to an amount of exposure based on exposure information obtained based on luminance information outputted from the wide-angle camera 101, there are cases where a captured image that is captured after a change of the exposure information becomes difficult to perceive due to a luminance change. Accordingly, the control unit 215 may change control information by processing such as the following when a difference D between a current amount of exposure of the zoom camera 102 and an amount of exposure based on exposure information obtained based on luminance information outputted from the wide-angle camera 101 is greater than a predetermined value. For example, the control unit 215 changes the control information so as to have an amount of exposure within a fixed range R from the current amount of exposure of the zoom camera 102. Note that the fixed range R may be changed in accordance with the difference D, such as by making the fixed range R larger the larger the difference D is.

### Second Variation

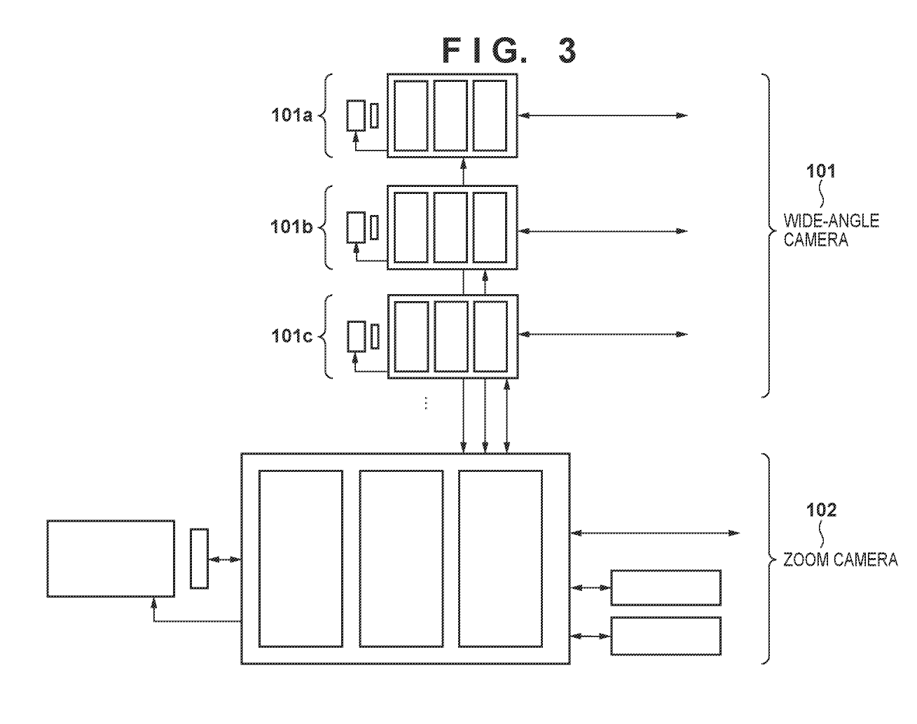

In FIGS. 1 and 2, the number of wide-angle cameras 101 is given as one, but it may be two or more. In such a case, as illustrated by FIG. 3, the monitoring apparatus 100 has wide-angle cameras 101a, 101b, 101c, . . . with the same configuration as the wide-angle camera 101, and the zoom camera 102, and the monitoring apparatus 100 can effectively capture a wider image capturing area than the monitoring apparatus 100 of FIGS. 1 and 2. Each of the wide-angle cameras 101a, 101b, 101c, . . . performs operation that is similar to that of the wide-angle camera 101. Here, the plurality of wide-angle cameras acquire images corresponding to an omnidirectional image capturing area by dividing and capturing 360 degrees around an axis in a vertical direction. For example, in a case of using four wide-angle camera, each captures an image capturing area of approximately 90 degrees for the pan direction. To capture the entirety of the monitoring region irrespective of, for example, distance to an object, it is desirable that the wide-angle cameras 101a, 101b, 101c, . . . have image capturing areas that slightly overlap one another.

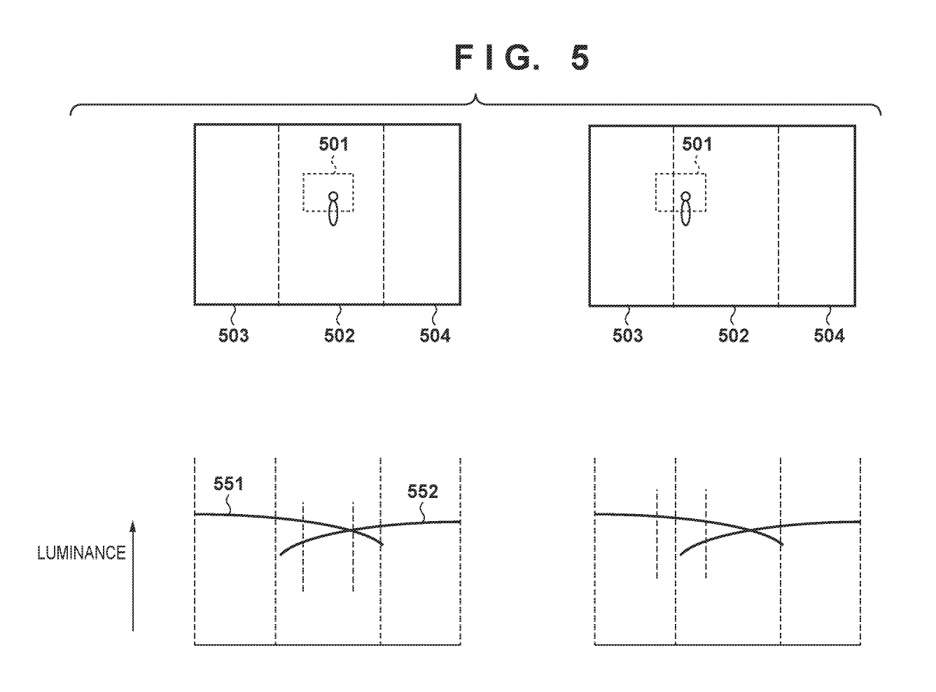

FIG. 5 is used to give a description regarding a luminance distribution in captured images for the plurality of wide-angle cameras. In FIG. 5, a region 502 and a region 503 are image capturing areas of a first wide-angle camera, and the region 502 and a region 504 are image capturing areas of the second wide-angle camera, in other words the region 502 is an overlap region where an image capturing area of the first wide-angle camera and an image capturing area of the second wide-angle camera are overlapping. In addition, in the lower-left graph and the lower-right graph of FIG. 5, the abscissa indicates the position in the horizontal direction for the regions 503, 502, and 504 in order from the left, and the ordinate indicates luminance. A curved line 551 indicates a luminance distribution in the horizontal direction for the image capturing area of the first wide-angle camera, and a curved line 552 indicates a luminance distribution in the horizontal direction for the image capturing area of the second wide-angle camera.

Near the edge of the angle of view of each wide-angle camera (near an edge portion of a captured image), the unreliability of luminance increases due to influences such as light falloff at edges for a lens. It is difficult to correct an overall captured image to a uniform sensitivity due to the variation of the characteristics of each lens or image sensor, in addition to the above. Accordingly, when luminance information is acquired from one wide-angle camera, a luminance level difference will occur by an object moving and the wide-angle camera incidentally changing.

Accordingly, when a predicted image capturing area 501 is positioned in the region 502 as illustrated by the top-left of FIG. 5, the control unit 215 obtains the average luminance information for the luminance information acquired from the first wide-angle camera and the luminance information acquired from the second wide-angle camera, and obtains exposure information from the average luminance information. By this, it is possible to reduce an influence such as light falloff at edges for a lens.

In addition, as illustrated by the top-right of FIG. 5, the predicted image capturing area 501 spans the region 502 and the region 503. At this point, the control unit 215 obtains a proportion W1 (0≤W1≤1) of the predicted image capturing area 501 that is occupying the image capturing area of the first wide-angle camera, and a proportion W2 (0≤W2≤1) of the predicted image capturing area 501 that is occupying the image capturing area of the second wide-angle camera. The control unit 215 obtains average luminance information (weighted average luminance information) of a result of weighting the luminance information acquired from the first wide-angle camera by the proportion W1 and a result of weighting the luminance information acquired from the second wide-angle camera by the proportion W2, and obtains exposure information from the average luminance information. By this, it is possible to reduce an influence such as light falloff at edges for a lens.

In this way, when a plurality of wide-angle cameras are used as the wide-angle camera 101, there are various methods for obtaining exposure information based on luminance information acquired for each wide-angle camera.

### Third Variation

A signal processing unit is installed in each camera in the monitoring apparatus 100 of FIGS. 1 through 3. However, configuration may be taken to, instead of installing a signal processing unit in each camera, install in the monitoring apparatus 100 one or more signal processing units for receiving and processing an electrical signal from an image sensor of each camera. Specifically, a functional unit for performing capturing and a functional unit for performing processing based on an image obtained by capturing may be held by a camera as in FIGS. 1 through 3, and may be different apparatuses.

### Fourth Variation

In the first embodiment, description was given for identifying (estimating) a predicted image capturing area from respective control amounts for a pan angle, a tilt angle, and a zoom value, but a method for identifying (estimating) a predicted image capturing area is not limited to this method. For example, configuration may be taken to identify (estimate) an object region (a region that includes an object) in the next frame from the position or movement direction of the object region in a captured image for a current frame, and set an image capturing area that includes the identified (estimated) an object region as the predicted image capturing area.

### Second Embodiment

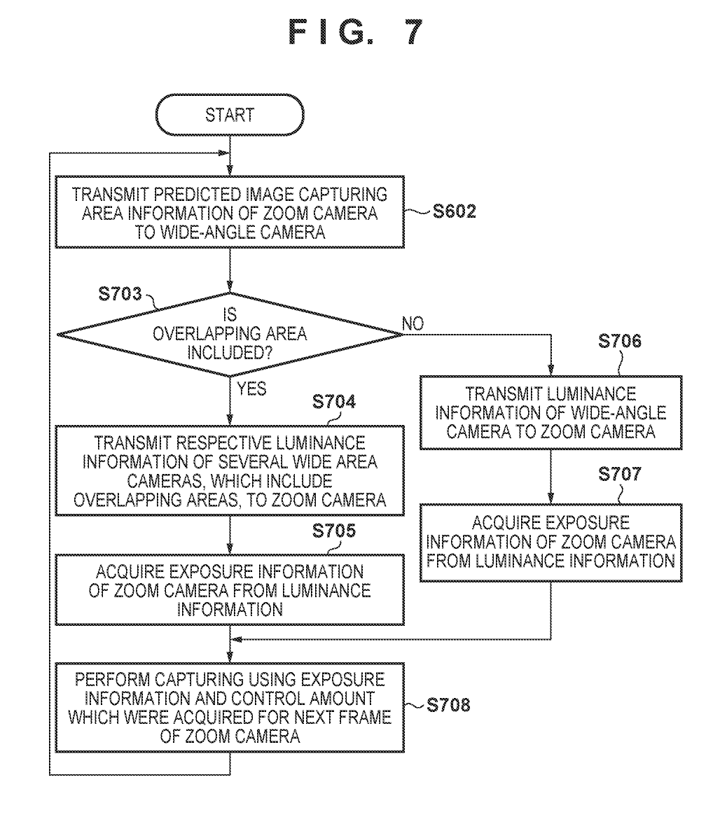

Description is given below regarding difference with the first embodiment, and the second embodiment is assumed to be the same as the first embodiment unless particular mention is made below. The present embodiment is applied to the monitoring apparatus 100 illustrated in FIG. 3. Description in accordance with the flowchart of FIG. 7 is given for operation of the monitoring apparatus 100 according to the present embodiment. In the flowchart of FIG. 7, the same step number is added to a processing step that is the same as that illustrated in FIG. 6, and description for this processing step is omitted.

In step S703, the control unit 205 of each wide-angle camera for the wide-angle cameras 101a, 101b, 101c, . . . operates as follows. In other words, the control unit 205 of the wide-angle camera of interest determines whether a predicted image capturing area indicated by predicted image capturing area information received from the zoom camera 102 belongs to an overlapping area where an image capturing area of this wide-angle camera overlaps with an image capturing area of another wide-angle camera. If there is a wide-angle camera out of the wide-angle cameras 101a, 101b, 101c, . . . that determines that the “predicted image capturing area belongs to an overlapping area where an image capturing area of this wide-angle camera overlaps with an image capturing area of another wide-angle camera”, the processing proceeds to step S704. In contrast, if there is no wide-angle camera out of the wide-angle cameras 101a, 101b, 101c, . . . that determines that the “predicted image capturing area belongs to an overlapping area where an image capturing area of this wide-angle camera overlaps with an image capturing area of another wide-angle camera”, the processing proceeds to step S706.

In step S704, luminance information for only wide-angle cameras that determined that the “predicted image capturing area belongs to an overlapping area where an image capturing area of this wide-angle camera overlaps with an image capturing area of another wide-angle camera” is outputted to the zoom camera 102.

In step S705, the control unit 215 obtains average luminance information for the luminance information outputted in step S704, and obtains exposure information from the average luminance information. Note that, in this step, configuration may be taken such that, for the top-right case of FIG. 5, the control unit 215 obtains luminance information in accordance with a weighted average as described above, and obtain the exposure information from the luminance information in accordance with the weighted average.

Meanwhile, in step S706, luminance information for only the wide-angle camera that determined that the “predicted image capturing area belongs to the image capturing area (excluding an overlapping area) of this wide-angle camera” is outputted to the zoom camera 102. In step S707, the control unit 215 obtains exposure information similarly to in the first embodiment, from the luminance information outputted in step S704.

In step S708, the control unit 215 controls the zoom lens 211 (strictly speaking a control unit for performing drive control of the zoom lens 211) and the image sensor 212 to change current exposure information of the zoom camera 102 to the exposure information obtained in step S705 or in step S707. In addition, processing similar to that of step S605 described above is performed in step S708.

In this way, by virtue of the present embodiment, even with a monitoring apparatus that uses a plurality of wide-angle cameras, it is possible to continue tracking capturing (monitoring) of an object even if there is a large change in luminance for the object or a vicinity thereof during tracking capturing.

### Third Embodiment

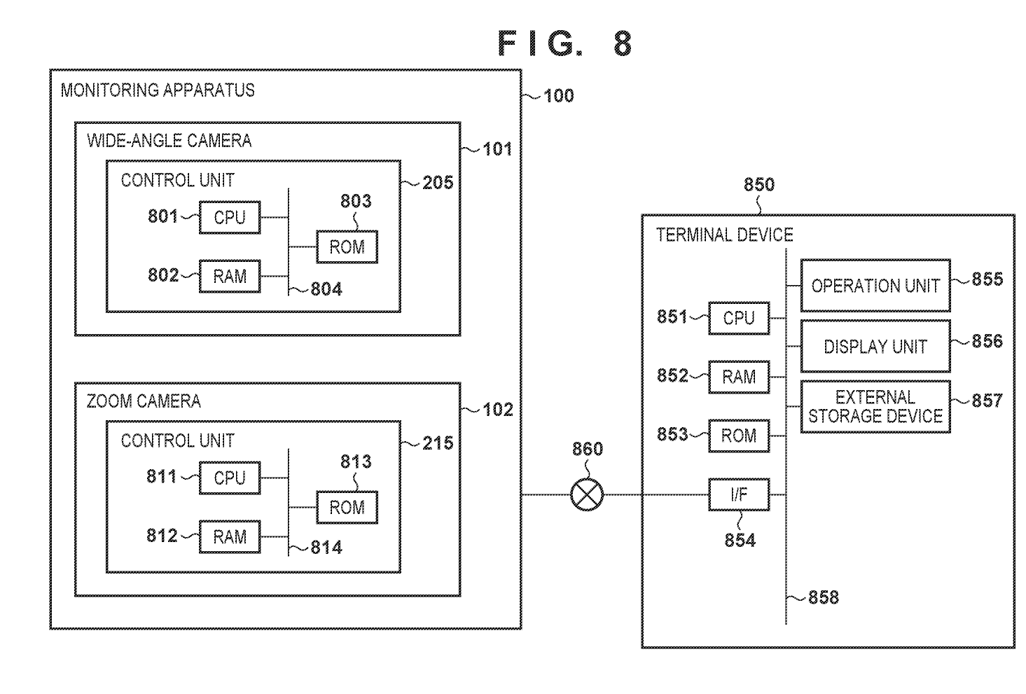

In the present embodiment, description is given regarding a system that has the monitoring apparatus 100 and a terminal device for handling images captured by the monitoring apparatus 100. The block diagram of FIG. 8 is used to give a description regarding an example of a configuration of the system according to the present embodiment. As illustrated by FIG. 8, the system according to the present embodiment has the monitoring apparatus 100 and a terminal device 850, and the monitoring apparatus 100 and the terminal device 850 are connected via a network 860. The network 860 is configured by a network such as the Internet or a LAN, and is a network that is configured wirelessly, by wire, or by a combination of wirelessly and by wire.

Firstly, description is given regarding the monitoring apparatus 100. The configuration of the monitoring apparatus 100 is as illustrated by FIG. 1, but in FIG. 8 detailed configurations are illustrated for the control unit 205 and the control unit 215, and illustration of other functional units is omitted.

The control unit 205 has a CPU 801, a RAM 802, and a ROM 803. The CPU 801 executes processing using data and a computer program stored in the RAM 802 to thereby perform operation control of the wide-angle camera 101 as a whole, and also executes or controls respective processing that was described above as being performed by the wide-angle camera 101. The RAM 802 has an area for storing a computer program or data loaded from the ROM 803, and data received from the zoom camera 102 or the terminal device 850. In addition, the RAM 802 has a work area that the CPU 801 uses when executing various processing. In this way, the RAM 802 can appropriately provide various areas. The ROM 803 stores a computer program and data for causing the CPU 801 to execute or control the respective processing described above as being performed by the wide-angle camera 101. The computer program and data stored in the ROM 803 is appropriately loaded into the RAM 802 in accordance with control by the CPU 801, and is subject to processing by the CPU 801. The CPU 801, the RAM 802, and the ROM 803 are each connected to a bus 804.

The control unit 215 has a CPU 811, a RAM 812, and a ROM 813. The CPU 811 executes processing using data and a computer program stored in the RAM 812 to thereby perform operation control of the zoom camera 102 as a whole, and also executes or controls respectively processing that was described above as being performed by the zoom camera 102. The RAM 812 has an area for storing a computer program or data loaded from the ROM 813, and data received from the wide-angle camera 101 or the terminal device 850. In addition, the RAM 812 has a work area that the CPU 811 uses when executing various processing. In this way, the RAM 812 can appropriately provide various areas. The ROM 813 stores a computer program and data for causing the CPU 811 to execute or control the respective processing described above as being performed by the zoom camera 102. The computer program and data stored in the ROM 813 is appropriately loaded into the RAM 812 in accordance with control by the CPU 811, and is subject to processing by the CPU 811. The CPU 811, the RAM 812, and the ROM 813 are each connected to a bus 814.

Next, description is given regarding the terminal device 850. The terminal device 850 is an information processing apparatus such as a smart phone, a tablet, or a PC (a personal computer). A CPU 851 executes processing using data and a computer program stored in a RAM 852 or a ROM 853 to thereby perform operation control of the terminal device 850 as a whole, and also executes or controls respectively processing that was described above as being performed by the terminal device 850.

The RAM 852 has an area for storing data or a computer program that is loaded from the ROM 853 or an external storage device 857, and data received from the monitoring apparatus 100 via an I/F 854 (an interface). In addition, the RAM 852 has a work area that the CPU 851 uses when executing various processing. In this way, the RAM 852 can appropriately provide various areas.

The ROM 853 stores data or a computer program for the terminal device 850 which does not need to be rewritten. The I/F 854 functions as an interface for performing data communication with the monitoring apparatus 100 via the network 860.

An operation unit 855 is configured by a user interface such as a mouse or a keyboard, and a user can input various instructions to the CPU 851 by operating the operation unit 855.

A display unit 856 is configured by a CRT, a liquid crystal screen, or the like, and can display a result of processing by the CPU 851 through an image, text or the like. For example, the display unit 856 may display a captured image that has been transmitted from the monitoring apparatus 100, or additional information as described above. In addition, the display unit 856 may be configured by a touch panel screen.

The external storage device 857 is a large capacity information storage apparatus that is typified by a hard disk drive device. The external storage device 857 stores an OS (operating system), and information handled as known information by the terminal device 850. In addition, the external storage device 857 stores a computer program or data for causing the CPU 851 to execute or control various processing performed by the terminal device 850. The computer program and data stored in the external storage device 857 is appropriately loaded into the RAM 852 in accordance with control by the CPU 851, and is subject to processing by the CPU 851.

The CPU 851, the RAM 852, the ROM 853, the I/F 854, the operation unit 855, the display unit 856, and the external storage device 857 are all connected to a bus 858. Note that a hardware configuration that can be applied to the monitoring apparatus 100, and a hardware configuration that can be applied to the terminal device 850 are not limited to the configurations illustrated in FIG. 8.

Some or all of the variations or embodiments described above may be appropriately used in combination. Also, the embodiments and modifications described above may be used in a selective manner either partially or wholly.

### Other Embodiments

Embodiment(s) of the present invention can also be realized by a computer of a system or apparatus that reads out and executes computer executable instructions (e.g., one or more programs) recorded on a storage medium (which may also be referred to more fully as ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-009940, filed Jan. 24, 2018, which is hereby incorporated by reference herein in its entirety.

What is claimed is:

1. A monitoring camera, comprising:
a first image capturing unit capable of changing an image capturing area for tracking capturing;
a second image capturing unit capable of capturing a wider angle than the first image capturing unit;
an acquisition unit configured to acquire luminance information of an image region corresponding to an image capturing area of the first image capturing unit in a next frame, from an image captured by the second image capturing unit; and
a control unit configured to control exposure for the first image capturing unit based on the luminance information.

2. The monitoring camera according to claim 1, wherein the acquisition unit identifies the image capturing area of the first image capturing unit in the next frame based on an object in a captured image of the first image capturing unit in a current frame, and acquires luminance information of an image region corresponding to the identified image capturing area from the image captured by the second image capturing unit.

3. The monitoring camera according to claim 1, wherein the control unit, in accordance with the luminance information, obtains information concerning exposure for the first image capturing unit, and controls the exposure for the first image capturing unit in accordance with the obtained information concerning exposure.

4. The monitoring camera according to claim 3, wherein the control unit controls exposure for the first image capturing unit in accordance with a difference between the information concerning exposure for the first image capturing unit obtained in accordance with the luminance information, and current information concerning exposure for the first image capturing unit.

5. The monitoring camera according to claim 1, wherein
the acquisition unit acquires the luminance information for, out of a plurality of the second image capturing units, the second image capturing unit whose image capturing area includes an object; and
the control unit controls exposure for the first image capturing unit based on the luminance information acquired by the acquisition unit.

6. The monitoring camera according to claim 1, wherein
the acquisition unit acquires the luminance information for, out of a plurality of the second image capturing units, the second image capturing unit whose image capturing area includes an object; and
the control unit controls exposure for the first image capturing unit based on average luminance information of the luminance information acquired by the acquisition unit.

7. The monitoring camera according to claim 1, wherein the first image capturing unit is an image capturing apparatus that can change a pan, a tilt, and a zoom.

8. The monitoring camera according to claim 1, wherein the second image capturing unit is one or more image capturing apparatuses having a wide-angle lens.

9. A method of controlling a monitoring camera having
a first image capturing unit capable of changing an image capturing area for tracking capturing, and
a second image capturing unit capable of capturing a wider angle than the first image capturing unit,
the method comprising:
acquiring luminance information of an image region corresponding to an image capturing area of the first image capturing unit in a next frame, from an image captured by the second image capturing unit; and
controlling exposure for the first image capturing unit based on the luminance information.

10. A non-transitory computer-readable storage medium storing a program for causing a computer to function as:
a first acquisition unit configured to acquire captured images from a first image capturing unit for which it is possible to change an image capturing area for tracking capturing, and a second image capturing unit for which capturing of wider angle than the first image capturing unit is possible; and
a second acquisition unit configured to acquire luminance information of an image region corresponding to an image capturing area of the first image capturing unit in a next frame, from an image captured by the second image capturing unit; and
a control unit configured to control exposure for the first image capturing unit based on the luminance information.
